(19) United States
(12) Patent Application Publication
(10) Pub. No.: US 2008/0032014 A1
(43) Pub. Date: Feb. 7, 2008

(54) Superabsorbent Printable Compositions

(75) Inventors: Volker Frenz, Altleiningen (DE); Martin Beck, Maxdorf (DE); Markus Tonnessen, Ludwigshafen (DE); Bernhard Steinmetz, Rutschenhausen (DE); Samantha Champ, Ludwigshafen (DE); Lothar Schaffeler, Siegburg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignee: BASF AKTIENGESELLSCHAFT, Ludwigshafen (DE)

(21) Appl. No.: 11/628,702

(22) PCT Filed: Jun. 3, 2005
(86) PCT No.: PCT/EP05/06005

§ 371 Date: Dec. 5, 2006

(30) Foreign Application Priority Data
Jun. 7, 2004 (DE) 10 2004 027 724.9

(51) Int. Cl. C09D 11/00; B41M 5/00; B65B 55/00

(52) U.S. Cl. 426/415; 106/31.13; 426/392; 428/195.1; 428/211.1

(57) ABSTRACT

The invention relates to a printable composition having a viscosity of 1-1000 mPas and comprising a) 5-50% by weight of superabsorbent polymeric particles, b) 10-40% by weight of at least one organic, water-insoluble binder, c) 0-10% by weight of at least one additive and d) 40-80% by weight of at least one organic solvent. The invention further relates to sheetlike materials printed with the printable composition on at least one surface. The invention further relates to the use of the printed sheetlike materials for food packaging, for packaging moisture-sensitive goods, for moisture control in rooms, or as a membrane in textiles.

This invention concerns a printable composition comprising superabsorbent polymeric particles, at least one binder, at least one additive and at least one organic solvent. This invention further concerns sheetlike materials printed with the printable composition on at least one surface and the use of the printed sheetlike materials for fluid absorption and/or fluid dispensation.

A printable formulation of a superabsorbent polymer is known from DE 195 21 431. It is a two-component swell paste comprising an aqueous, lightly crosslinked polyacrylic acid and a reactive crosslinker. After the two components have been added together, the mixture becomes increasingly viscous and has to be applied within a few hours to the materials to be printed. This is accomplished, for example, by printing or knife coating on textiles or sheetlike structures such as paper or foils for example, and a screen can be used to achieve the uniform pattern. Subsequently, the applied polymer has to be crosslinked by thermal treatment. Disadvantages of the printable composition described in DE 195 21 431 are that, after the two components have been mixed, there is only a limited time span available to process the printable composition, and that crosslinking to form the superabsorbent polymer is still taking place during and after the printing operation, making it impossible to produce polymeric particles of defined size. A further disadvantage is the use of an aqueous system, which causes the superabsorbent polymer to swell.

DE 196 52 762 describes a superabsorbent thermoplastic composition comprising superabsorbent, a binder and an additive which comprises a water-soluble component. There is no solvent in the composition. This superabsorbent thermoplastic composition is used for producing watertight structures, especially longitudinally watertight cable structures. A disadvantage of this superabsorbent thermoplastic composition is that it is only liquid at temperatures from 140 to 160° C. and therefore is not suitable for use in a printing process.

EP 0 188 959 discloses a coating composition comprising superabsorbent polymeric particles, a water-soluble binder, various additives and also an organic solvent, preferably methanol or ethanol. The composition is knife coated onto materials such as textiles, paper or plastic. When a material coated with the composition of EP 0 188 959 absorbs an aqueous fluid, the water solubility of the binder in the composition will cause detachment of the water-absorbing layer from the particular substrate. This leads to the decisive disadvantage that the process of fluid acquisition is not reversible.

DE 2 441 781 discloses a process for improving the water uptake of fiber materials wherein modified cellulose ethers are used as an absorbent material and are fixed to the fiber materials with the aid of dressing agents, resins or binders from aqueous solutions. The aqueous solution comprising the cellulose ethers and also the fixing agents is applied to the fiber materials by spraying, immersion or brushing before fixing is effected by heating. Detachment of the absorbent layer on uptake of water is prevented according to DE 2 441 781 by fixing using binders. One disadvantage is the use of aqueous solutions, which causes the cellulose ethers to swell even in the course of the production of the absorbent fibrous materials.

DE 195 05 708 discloses sheetlike superabsorbent materials comprising at least one superabsorbent polymer and at least one water-soluble polymer formed into a sheetlike matrix. The superabsorbent polymer is not included in a printable composition; instead, a viscous solution of the water-soluble polymer is applied to a surface and this water-soluble polymer is then besprinkled with the superabsorbent polymer. Chemical or physical bonds may form between the water-soluble matrix material and the superabsorbent polymer in the course of subsequent drying. The superabsorbent polymer can additionally be fixed by treatment with an embossing water roll. The water solubility of the sheetlike matrix to which the superabsorbent polymer is applied causes the matrix to detach when the superabsorbent polymer takes up water. Disadvantages of the invention described in DE 195 05 708 are the deficient fixing of the sprinkled superabsorbent polymer on the sheetlike matrix and the detachment of the matrix on water absorption.

WO 00/64311 describes a hydrophilic sheetlike material consisting of a matrix in the form of a braid having individual fibers or an open-cell polymeric foam and a superabsorbent polymerized onto the matrix. The hydrophilic sheetlike material forms part of a seat cushion or lying furniture. Application of the superabsorbent to the matrix by, for example, spraying and a subsequent addition polymerization process lead to the formation of a durable bond between the superabsorbent and the matrix in that this bond does not break even when the superabsorbent takes up water. But the invention according to WO 00/64311 is not a printable composition which is fixed on a matrix using binders.

This invention has for its object to provide a printable composition which can be applied to sheetlike materials using conventional printing processes, firmly adheres to sheetlike materials and permits reversible absorption and/or dispensation of aqueous fluids.

We have found that this object is achieved according to the invention by a printable composition having a viscosity of 1-1000 mPas and comprising

a) 5-50% by weight of superabsorbent polymeric particles,

b) 10-40% by weight of at least one organic, water-insoluble binder,

c) 0-10% by weight of at least one additive and

d) 40-80% by weight of at least one organic solvent.

A printable composition according to the invention contains for example:
a) 14.0% per weight of superabsorbent polymeric particles (cross-linked sodium-polyacrylate),
b) 23.0% per weight organic, water-insoluble binder (thereof: 18.0% per weight acrylate; 3.0% per weight polyester and 2.0% per weight maleate resin),
c) 2.0% per weight additives (citric acid ester)
d) 61.0% per weight organic solvent (thereof: 50.5% per weight acetic ethyl ester and 10.5% per weight methyl ethyl ketone).

This printable composition has a viscosity of 108 mPas.

The object is further achieved by sheetlike materials printed with the printable composition on at least one surface.

The object is further achieved by the use of the printed sheetlike materials for food packaging, for packaging moisture-sensitive goods, for moisture control in rooms or as a membrane in textiles.

As used herein, “printable” refers to a composition which can be applied to sheetlike materials by conventional printing processes, especially gravure printing. The printability of the composition according to the present invention is determined in particular by the viscosity. If the viscosity is too low, the composition will escape from the wells in the gravure-printing roll; if it is too high, not all the composition is transferred to the sheetlike material.

As used herein, “superabsorbent” refers to the property of hydrophilic materials to absorb, and also retain under pressure, large amounts of water or aqueous fluids without being immediately dissolved. A superabsorbent material is capable of taking up a multiple of its own weight of water or of an aqueous fluid. Examples of superabsorbent materials include not only polyacrylic acid and salts of polyacrylic acid but also derivatives of starch or cellulose, carboxymethylcellulose or polyacrylamide.

As used herein, “binder” refers to materials capable of securing the constituents of the printable composition in the printed layer and of adhering the printed layer to the sheetlike material.

As used herein, “sheetlike materials” are materials which combine an essentially two-dimensional expanse with low thickness and can be printed using conventional printing processes.

As used herein, “room” is to be understood in its broadest meaning, comprising e.g. living space, offices, halls, cellars, and garages.

The present invention's printable composition comprising superabsorbent polymers offers the following advantages over the prior art: Owing to a suitable viscosity, the composition can be printed onto sheetlike materials by conventional printing processes simply, rapidly and economically. It is also possible in this connection to print bounded regions only. The organic, water-insoluble binder combines with the additive to ensure that the superabsorbent polymeric particles are fixed not only in the printed layer but also through this layer on the sheetlike material. This fixing and also the water insolubility of the binder prevents detachment of the printed layer from the substrate even when comparatively large amounts of water or aqueous fluids have been taken up, and this ensures reversible absorption and/or release of aqueous fluids. The use of an organic solvent prevents any swelling of the superabsorbent polymeric particles in the printable composition before printing onto the sheetlike materials.

In a particular embodiment of the present invention the solids content of the composition is in the range from 20% to 50% by weight. Together with the viscosity of 1-1000 mPas, and preferably 100-500 mPas for the printable composition, this solids content makes it possible to achieve add-on weights (amounts of transferred printable composition solids) of 1 to at least 30 g/m².

Any superabsorbent polymeric particles are suitable. Advantageously, the superabsorbent polymeric particles consist of polyacrylate and especially of sodium polyacrylate, the polyacrylate consisting of a 50 mol % neutralized polymer comprising acid groups and comprising monoethylenically unsaturated monomers and crosslinkers.

The superabsorbent polymeric particles are preferably from 5 to 50 μm and especially from 10 to 45 μm in size.

The organic, water-insoluble binders are selected as customary in this industrial sector. Examples for useful organic, water-insoluble binders include nitrocellulose, polyvinyl butyral, polyvinyl chloride (co)polymers, polyamides, acrylate resins, and polyurethanes. These materials are used as binders in paint manufacture. The identity of the binder or binders chosen for the printable composition depends on the planned application of the sheetlike materials printed with the superabsorbent composition. For example, the binder has to be suitable for food contact when the printed sheetlike materials are to be used in the food sector. This condition is satisfied inter alia by specialty vinyl chloride copolymers or vinyl butyral copolymers used for direct food contact.

Advantageously, there is or are plasticizer additives included in the printable composition. These plasticizer additives are selected as customary in this industrial sector. Examples for useful plasticizer additives include acetyl tributyl citrate, adipate plasticizers, phthalate plasticizers, and epoxidized soybean oils. Further additives such as waxes and leveling agents can also be included in the printing composition. Like the binders, these additives are used for paint manufacture. The plasticizers mentioned are low-volatile organic liquids. Their purpose is to keep the printed layer, consisting of the printable composition, elastic on the sheetlike materials and prevent any embrittlement.

Leveling agents are employed in order to provide for a high levelness of the sheet like materials printed with the superabsorbent composition of the invention. There are many possible causes that give rise to leveling defects of a printed surface, such as the composition of the paint, the course of the drying process, temperature and ventilation, and film forming. The most common form of leveling defect is the so called orange peel, generated by a surface structure with dimensions of 0.2 to 10 mm.

Examples for leveling agents are butylglycol acetate, butyltriglycol, Depanol®, that comprises a mixture of different p-menthadienes, Depanol N IV®, that comprises a mixture of monoterpene hydrocarbons with oxygenated terpene derivatives, butyl acetates, such as n-butyl acetate, isobutyl acetate and methyl propyl acetate, 2-ethoxyethyl acetate, ethyldiglycol, ethylene glycol monoethylether, isononanol, mesityl oxide, 1-methoxy-2-propanol acetate, methylbutanols, such as amyl alcohol and 3-methyl-1-butanol, methyldiglycol, methylglycol, propylene glycol 1-ethyl ether, and propylene glycol 1-methylether.

Examples for preferred organic solvents for the printable composition are esters, such as ethylacetate, propylacetate, butylacetate, and methoxypropylacetate, alcohols, such as ethanol, N-propanol, iso-propanol, and methoxybutanol, and ketones, such as methylethylketone and acetone. Again, these materials are used in paint manufacture. The function of the solvents is to adjust the composition to the viscosity required for printing. The required viscosity is dependent on the speed of the printing machines and on the material to be printed. The organic solvents contain less than 0.3% by volume, preferably less than 0.1% by volume and more preferably less than 0.01% by volume of water.

In principle, any sheetlike material printable by conventional printing processes can be printed with the composition of the present invention.

The sheetlike materials printed with the printable composition on at least one surface are preferably polymeric foils, metal foils or paper. Preferred polymeric foils are polyethylene, polypropylene, OPP (oriented polypropylene) and polyethylene terephthalate foils. Aluminum foil is a preferred metal foil and paper includes wallpaper.

A preferred embodiment for a sheet like material which is to be printed is a polyethylene foil with a thickness of 30 μm. One or both surfaces of this foil are printed with the above mentioned printable composition by gravure printing.

In a further embodiment of the present invention, the sheetlike materials printed with the composition of the present invention are textiles or textile fibers, including nonwovens. Preferred embodiments of textile fibres are non-wovens with a thickness of 30 μm.

The present invention's printable composition is preferably printed onto the sheetlike materials by gravure printing and the solvent is subsequently removed by heating. Depending on the applications planned for the sheetlike materials printed with the composition of the present invention, the sheetlike materials can be printed over the whole area or only in selected regions.

Gravure printing involves printable compositions (lacquers and printing inks) being transferred from a reservoir vessel (the ink trough) to a printing cylinder. Impressions, known as wells, are engraved in this cylinder to accommodate the ink or lacquer. The excess ink or lacquer is knife-coated off. The material to be printed is led between the printing cylinder and a backup impression cylinder, and the ink or lacquer transfers to the material to be printed. Foil materials (polymeric and metal foils) and paper are used as materials to be printed.

The printing cylinder for the gravure process for printing the composition of the present invention can be an ordinary engraved roll. For example, an engraved roll having 18 lines per cm, a depth of 135 μm, a wall width of 16 μm and a surface area of 285.113 μm² is used. The printing cylinder used can also be a hatched roll. It has for example 18 lines per cm with a depth of 98 μm, a wall thickness of 34 μm, a diameter of 191 mm and a line width of 523 μm. One advantage of a hatched roll is the ability to print particularly large amounts of printable composition onto the sheetlike materials.

After the printing operation, the solvent of the printable composition is removed by heating. This is done in dryers, which are a standard component of gravure printing machines.

The invention further provides for the use of the sheetlike materials printed with the composition of the present invention as packaging. Examples of goods to be packed are food products or moisture-sensitive goods such as building materials, examples being cement or sand. The printed side of the sheetlike materials always faces the moisture-sensitive contents. It is also possible to use for packaging sheetlike materials printed only in selected regions. This makes it possible for example to conform the superabsorbent print on the sheetlike packaging material to the particular contents.

For the use of sheet-like materials printed with the composition according to the present invention as packaging for moisture-sensitive goods, a polyethylene foil with a thickness of 30 μm is used preferably. The side of the foil which is to face the moisture-sensitive goods is printed with the above mentioned printable composition by gravure printing. Subsequently, a semipermeable polymeric foil is laminated to the side already printed with superabsorbents by means of a solvent-free laminating adhesive. The permeable side of this foil faces the contents. Polyethylene foil printed in this way is used, e.g., to pack bakery products.

For the use of sheet-like materials printed only in selected regions with the composition according to the invention, thermoplastic, sealable foil is used, for example. Thereby, the regions that are to be sealed later on are omitted when printing with the composition according to the invention.

The invention further provides for the use of the printed sheetlike materials for moisture control in rooms. Examples thereof are the use of materials printed with the composition of the present invention as wallpapers or the application of the printed materials to furniture. In either case, the printed side of the materials faces the room's interior.

By use of polyethylene foils printed on one or two sides, the formation of condensation water in closed containers can be prevented, for example.

It is also advantageous to use the printed sheetlike materials as a membrane in textiles, especially in functional clothing. The superabsorbing printed material, for example textiles and textile fibers, takes up fluids such as perspiration and conducts them to a breathable membrane which transports the moisture to the outside.

1.-12. (canceled)

13. A printable composition having a viscosity of 1-1000 mPas and comprising
a) 5-50% by weight of superabsorbent polymeric particles,
b) 10-40% by weight of at least one organic, water-insoluble binder,
c) 0-10% by weight of at least one additive and
d) 40-80% by weight of at least one organic solvent.

14. The printable composition according to claim 13 wherein the solids content of the composition is 20-50% by weight.

15. The printable composition according to claim 13 wherein the superabsorbent polymeric particles comprise a polyacrylate.

16. The printable composition according to claim 13 wherein the superabsorbent polymeric particles comprise a sodium polyacrylate.

17. The printable composition according to claim 13 wherein the particle size of the superabsorbent polymeric particles is in the range from 5 to 50 μm.

18. The printable composition according to claim 13 wherein the binders of component b) are selected from the group consisting of nitrocellulose, polyvinyl butyral, polyvinyl chloride (co)polymers, polyamides, acrylate resins, and polyurethanes.

19. The printable composition according to claim 13 wherein the additives of component c) are selected from the group consisting of acetyl tributyl citrate, adipate plasticizers, phthalate plasticizers, and epoxidized soybean oils.

20. The printable composition according to claim 13 wherein the organic solvents of component d) are selected from the group consisting of ethyl acetate, propyl acetate, butyl acetate, methoxypropyl acetate, ethanol, n-propanol, iso-propanol, methoxybutanol, methyl ethyl ketone, and acetone.

21. Sheetlike materials printed on at least one surface with the printable composition according to claim 13.

22. The printed sheetlike materials according to claim 21 wherein the sheetlike materials are selected from the group consisting of polymeric foils, metal foils, and paper.

23. The printed sheetlike materials according to claim 21 wherein the sheetlike materials are selected from the group consisting of textiles and textile fibers.

24. A method of packaging food or moisture-sensitive goods wherein said food or moisture-sensitive goods are packed with sheetlike materials printed on at least one surface with the printable composition according to claim 13.

25. The printable composition according to claim 14 wherein the solids content of the composition is 25-45% by weight.

26. The printable composition according to claim 17 wherein the particle size is in the range from 10 to 45 μm.

27. The method according to claim 24 wherein the sheetlike materials are selected from the group consisting of polymeric foils, metal foils, and paper.

28. A method of controlling moisture in rooms wherein the sheetlike materials according to claim 21 are positioned within said rooms.

29. The method according to claim 28 wherein the sheetlike materials are selected from the group consisting of polymeric foils, metal foils, and paper.

30. A method of producing a membrane in textiles, wherein the sheetlike materials according to claim 21 are attached onto textiles.

31. The method according to claim 30 wherein the sheetlike materials are selected from the group consisting of polymeric foils, metal foils, and paper.

32. The printed sheetlike materials according to claim 23 wherein the textiles and textile fiber are non-wovens.
